(19) United States
(12) Patent Application Publication
(10) Pub. No.: US 2008/0294891 A1
(43) Pub. Date: Nov. 27, 2008

(54) Method for Authenticating a Mobile Node in a Communication Network

(75) Inventors: Vishnu Ram OV, Bangalore (IN); Vihang G. Gangaram Kamble, Bangalore (IN); Saumya G. Upadhyaya, Bangalore (IN)

Correspondence Address: Motorola, Inc.;Law Department, 1303 East Algonquin Road, 3rd Floor, Schaumburg, IL, 60196, US

(73) Assignee: MOTOROLA, INC., SCHAUMBURG, IL (US)

(21) Appl. No.: 12/187,431

(22) Filed: Aug. 7, 2008

(30) Foreign Application Priority Data
Mar. 10, 2006 (IN) 643/DEL/2006

(51) Int. Cl. H04L 9/32

(52) U.S. Cl. 713/158; 713/155; 713/156

(57) ABSTRACT

A method for authenticating a mobile node (102) in a communication network (100) is provided. The communication network includes at least one proxy server and a home server. The mobile node and the home server include a shared key. The shared key uniquely associates the mobile node with the home server. The method at the mobile node includes sending (204) a request for an Internet Protocol (IP) address to at least one proxy server. Further, the method includes receiving (206) a nonce in response to the request, from a proxy server of the at least one proxy server. The method also includes deriving (208) a session key, based on the nonce and the shared key. The session key authenticates the mobile node to initiate a secure communication session with the proxy server.

This invention relates generally to communication networks, and more particularly, to a method for authenticating a mobile node in a communication network.

### BACKGROUND OF THE INVENTION

With increasing need for communication and information exchange, communication networks are becoming increasingly popular. They enable users to share resources and communicate amongst themselves. There are different types of communication networks, for example, mobile communication networks and computer networks. Typically, a mobile communication network includes at least a home server and one or more mobile nodes. Some examples of mobile nodes include mobile phones, personal digital assistants (PDAs), laptop computers, and messaging devices. The mobile devices in a mobile communication network securely communicate using a home server.

A mobile communication network has an advantage that it allows users to communicate with each other even when they are mobile, for example, in a home network or a foreign one. However, a mobile communication network is vulnerable to security threats. For example, an unauthorized mobile node may enter a mobile communication network and repeatedly keep making requests for IP addresses from a proxy server by using fake identities. This may exhaust a portion of the IP addresses available with the proxy server. Further, the unauthorized mobile node can consume the network's resources without being traceable by the service provider. In such a scenario, the unauthorized mobile node can interfere with the network's accounting system, for example, it can lead to false billing of another mobile node whose identity the unauthorized mobile node is using.

Similarly, a proxy server delivering information to the mobile node can be an unauthorized proxy server. For example, when the mobile node enters a foreign network and makes a request for an IP address, this request may be directed to an unauthorized proxy server, which will provide the mobile node with an invalid address. Consequently, an authorized mobile node entering the network will not be able to acquire an address, and will therefore be unable to access the network. In another scenario, the IP address provided by the unauthorized proxy server may cause the mobile node to be routed to invalid resources on the network, where the mobile node may unknowingly download a destructive program, for example, a virus. This can pose a security threat for mobile nodes. Consequently, a mobile node and a proxy server providing information to mobile nodes in a communication network need to be authenticated for secure communication.

### BRIEF DESCRIPTION OF THE FIGURES

The accompanying figures where like reference numerals refer to identical or functionally similar elements throughout the separate views, and which, together with the detailed description below are incorporated in and form part of the specification, serve to further illustrate various embodiments and to explain various principles and advantages all in accordance with the present invention.

FIG. 1 illustrates an exemplary communication network, in accordance with an embodiment of the present invention;

FIG. 2 is a flow diagram illustrating a method for authenticating a mobile node in a communication network, in accordance with an embodiment of the present invention;

FIG. 3 is a message-flow diagram illustrating a method for authenticating a mobile node in a communication network, in accordance with an embodiment of the present invention;

FIG. 4 is a flow diagram illustrating a method for authenticating a mobile node in a communication network, in accordance with another embodiment of the present invention;

FIG. 5 is a flow diagram illustrating a method for authenticating a mobile node in a communication network, in accordance with yet another embodiment of the present invention; and

FIG. 6 is a message-flow diagram illustrating a method for authenticating a mobile node in a communication network, in accordance with another embodiment of the present invention.

### DETAILED DESCRIPTION

Before describing in detail the particular method for authenticating a mobile node in a communication network in accordance with various embodiments of the present invention, it should be observed that the present invention resides primarily in combinations of method steps related to authentication of a mobile node in a communication network. Accordingly, the method steps have been represented, where appropriate, by conventional symbols in the drawings, showing only those specific details that are pertinent to understanding the present invention, so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The term “another,” as used in this document, is defined as at least a second or more. The terms “includes” and/or “having”, as used herein, are defined as comprising.

In an embodiment, a method for authenticating a mobile node in a communication network is provided. The communication network includes a mobile node, at least one proxy server and a home server. The mobile node and the home server store a shared key. The shared key uniquely associates the mobile node with the home server. The method at the mobile node includes sending a request for an Internet Protocol (IP) address to the at least one proxy server. Further, the method includes receiving a nonce, in response to the request, from a proxy server of the at least one proxy server. Moreover, the method includes deriving a session key, based on the nonce, and the shared key. The session key authenticates the mobile node to initiate a secure communication session with the proxy server.

In another embodiment, another method for authenticating a mobile node in a communication network is provided. The communication network includes the mobile node, at least one proxy server, and a home server. The mobile node and the home server store a shared key. The shared key uniquely associates the mobile node with the home server. The method at a proxy server of the at least one proxy server includes receiving a request for an Internet Protocol (IP) address from the mobile node, and sending the request to the home server. Further, the method includes receiving a nonce from the home server and providing the nonce to the mobile node. The method also includes receiving a session key from the home server. The session key authenticates the mobile node to initiate a secure communication session with the proxy server.

In yet another embodiment, a method for authenticating a mobile node in a communication network is provided. The communication network includes a mobile node, at least one proxy server, and a home server. The mobile node and the home server store a shared key. The shared key uniquely associates the mobile node with the home server. The method at the home server includes receiving a request from a proxy server of the at least one proxy server for authenticating the mobile node. Further, the method includes validating the mobile node. The method also includes deriving a nonce when the one or more parameters of a session key do not exist. Further, the method includes driving the session key based on the nonce and the shared key when the one or more parameters of the session key do not exist. The session key authenticates the mobile node to initiate a secure communication session with the proxy server. Moreover, the method includes providing the nonce and the session key to the proxy server.

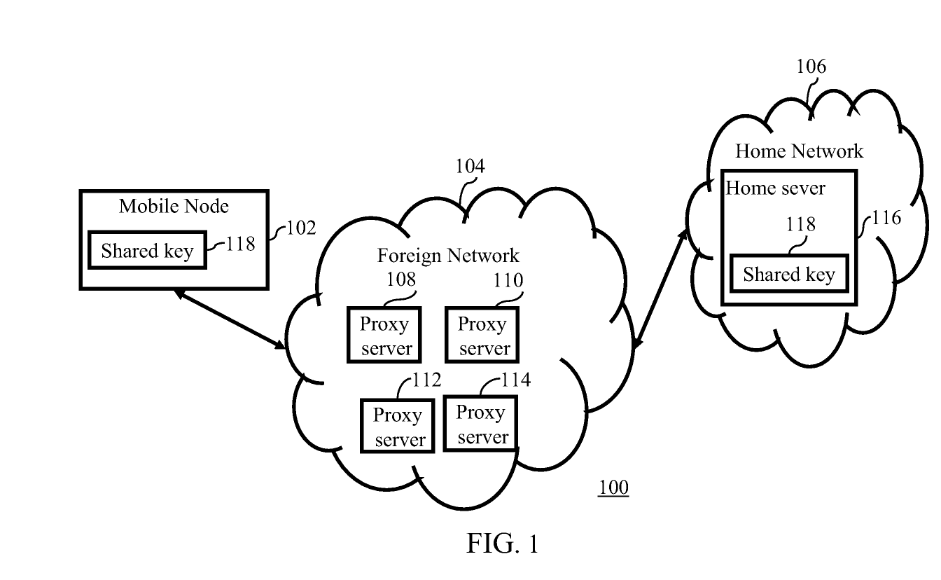

FIG. 1 illustrates an exemplary communication network 100, in accordance with an embodiment of the present invention. Examples of the communication network 100 include, but are not limited to, IEEE 802.16-based broadband wireless access networks, Advanced Mobile Phone System (AMPS) networks, Global System for Mobile Communications (GSM) networks, Digital Cellular Systems (DCS) networks, and Universal Mobile Telecommunication Systems (UMTS) networks. For the purpose of this description, the communication network 100 is shown to include a mobile node 102, a foreign network 104, and a home network 106. Examples of the mobile node 102 include, but are not limited to, cellular phones, laptop computers, Personal Digital Assistants (PDAs), and messaging devices. The foreign network 104 can include one or more proxy servers. For the purpose of this description, the foreign network 104 is shown to include a proxy server 108, a proxy server 110, a proxy server 112, and a proxy server 114. Examples of the one or more proxy servers include, but are not limited to, DHCP servers, a Bootstrap Protocol (BOOTP) servers, Serving GPRS Service Nodes (SGSNs), Packet Data Serving Nodes (PDSNs), and Wireless Access Points (WAPs). The home network 106 can includes a home server 116. Further, the home server 116 and the mobile node 102 store a shared key 118, which uniquely associates the mobile node 102 with the home server 116. The home server 116 authenticates the mobile node 102 by using the shared key.

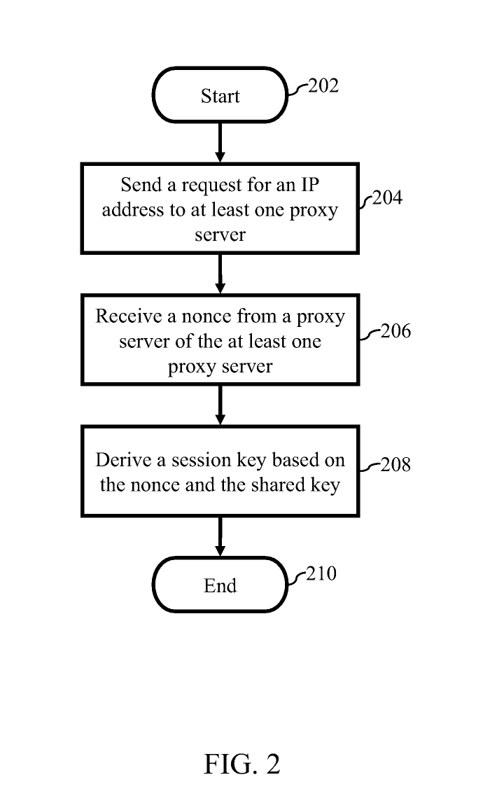

FIG. 2 is a flow diagram illustrating a method for authenticating a mobile node in the communication network 100, in accordance with an embodiment of the present invention. After initiating the process at step 202, a request for an Internet Protocol (IP) address is sent by the mobile node to at least one proxy server at step 204. The request can be sent by the mobile node 102 to at least one of the proxy server 108, the proxy server 110, the proxy server 112, and the proxy server 114. In an embodiment, the request for an IP address can include a Network Access Identifier (NAI). The NAI enables a proxy server, for example, the proxy server 110, to identify a mobile node, for example, the mobile node 102. Further, the NAI can be used by the proxy server 110 to route the request to the home server 116 with which the mobile node 102 is associated. At step 206, a nonce is received from the proxy server. For example, the mobile node 102 receives the nonce form the proxy server 110 in response to the request sent by the mobile node. An example of the nonce includes, but is not limited to, a random number. In an embodiment, the mobile node 102 also receives authorized configuration options from the proxy server 110. Examples of the authorized configuration options include, but are not limited to, a Trivial file transfer protocol (Tftp) server name, a Mobile IP (MIP) Home Agent Internet Protocol (HA IP) address, and a boot filename. The Tftp server name is the address of a server from where the boot file could be picked up when a request from the mobile node 102 is received. The MIP HA IP address is the IP address of the server in the home network 106, which provides the MIP home agent functions for the mobile node 102. The boot filename is the name of the file which contains the boot parameters for the mobile node 102. In an embodiment, the authorized configuration options can include services the mobile node 102 is allowed to access. Examples of these services include, but are not limited to, IP address filtering, address assignment, route assignment, and Quality of Service (QoS) services. In an embodiment, the authorized configuration options are stored at the mobile node 102. In an embodiment, the mobile node further receives an authentication certificate from the proxy server 110. This authentication certificate received by the proxy server 110 validates the proxy server 110.

At step 208, the mobile node 102 derives a session key based on the nonce and the shared key 118. The session key can be derived by applying a hash function, an Exclusive OR (XOR) function, a simple concatenation function, or an addition function on the nonce and the shared key 118. The hash function has a property that different input values to the hash function will always results in different outputs. For example, if input values ‘ABCDE’ and ‘GHIJ’ are hashed by using a hash function to generate ‘123’ as an output, then the any other input values will not generate ‘123’ as an output. The session key authenticates the mobile node 102 to initiate a secure session with the proxy server 110. In an embodiment, the mobile node 102 receives a notification from the proxy server 110 when one or more parameters, for example, the lifetime of the session key, expire. In an embodiment, services to the mobile node 102 can be terminated when the one or more parameters of the session key expire. Thereafter, the process terminates at step 210.

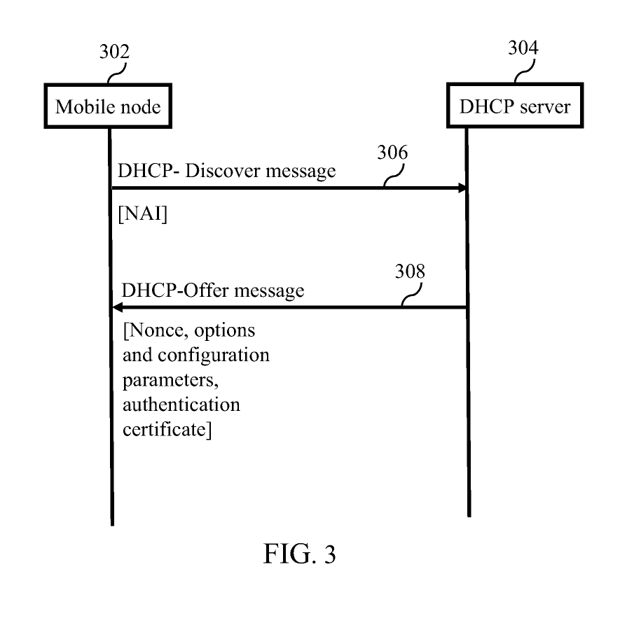

FIG. 3 is a message flow diagram illustrating a method for authenticating a mobile node in the communication network 100, in accordance with an embodiment of the present invention. The following method will be explained in conjunction with a Dynamic Host Configuration Protocol (DHCP) server; a Home Authentication, Authorization, and Accounting (AAAH) server; and an Authentication, Authorization and Accounting (AAA) protocol. Details of the AAA system can be found in a research paper titled ‘AAA Protocols: Authentication, Authorization, and Accounting for the Internet’, published in IEEE Internet Computing, Volume 03, Issue 6, pp. 75-79, in 1999. In an embodiment, when a mobile node, for example, a mobile node 302, enters a foreign network 104, the mobile node 302 sends a request for an Internet Protocol (IP) address to the DHCP server, for example, a DHCP server 304. In an embodiment, the mobile node can send a DHCP request, for example, a DHCP-discover message 306, to the DHCP server 304. In an embodiment, the DHCP-discover message 306 can include a Network Access Identifier (NAI), which enables the DHCP server 304 to identify the mobile node 302. Further, the NAI can be used by the DHCP server 304 to route the request to the AAAH server. The DHCP server 304 provides at least one parameter to the AAAH server. The at least one parameter is specific to the request sent by the mobile node 302. In response to the DHCP-discover message 306, the mobile node 302 receives a DHCP-offer message 308 from the DHCP server 304. The DHCP-Offer message 308 can include a nonce. After the nonce is received at the mobile node 302, the mobile node 302 derives the session key, which authenticates the mobile node 302 to initiate a secure communication session with the DHCP server 304.

In an embodiment, the DHCP-offer message 308 also includes the authorized configuration options. In an embodiment, the authorized configuration options are stored at the mobile node 302. In an embodiment, the DHCP-offer message 308 also includes an authentication certificate, which is received by the mobile node and validates the DHCP server 304. In an embodiment, the mobile node 302 receives a notification from the DHCP server 304 when the one or more parameters of the session key expire.

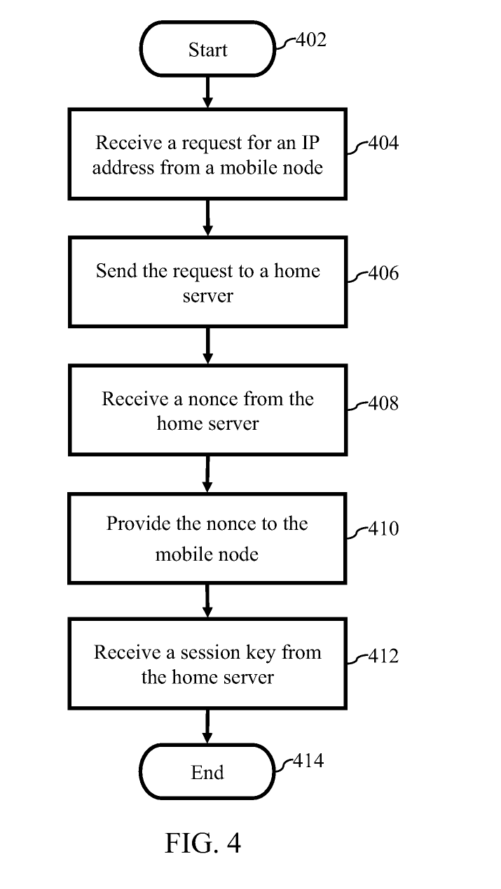

FIG. 4 is a flow diagram illustrating a method for authenticating a mobile node in a communication network, in accordance with another embodiment of the present invention. After initiating the process at step 402, a request for an Internet Protocol (IP) address is received by a proxy server at step 404. For example, the request is received by the proxy server 110 from the mobile node 102. In an embodiment, the request can include a Network Access Identifier (NAI), which enables a proxy server to identify a mobile node. Further, the NAI can be used by the proxy server 110 to route the request to the home server 116. In an embodiment, the proxy server 110 also receives the authorized configuration options for the mobile node 102 from the home server 116. In this embodiment, the authorized configuration options are provided to the mobile node 102. At step 406, the proxy server 110 sends the request to the home server 116. In an embodiment, the request can include at least one parameter, which can be used by the home server, for example, the home server 116, to calculate the parameters of the session key. For example, the proxy server 110 can include a proposed IP lease time in the request, which can be used by the home server 116 to calculate the lifetime of the session key.

In an embodiment, the proxy server 110 sends a request to the home server 116 to validate the mobile node 102. In another embodiment, the proxy server 110 sends an authentication certificate to the home server 116, to sign the authentication certificate. The home server 116 signs the authentication certificate by using different technologies, and returns it to the proxy server 110. Examples of the different technologies include, but are not limited to, a digital signature, a Public Key Infrastructure (PKI), and a session key based signing. The proxy server receives the authentication certificate from the home server 116 and sends it to the mobile node 102. The authentication certificate validates the proxy server 110. At step 408, the proxy server 110 receives a nonce from the home server 116. At step 410, the proxy server 110 provides the nonce to the mobile node 102. At step 412, the proxy server receives the session key from the home server 116. In an embodiment, the proxy server 110 simultaneously receives the nonce and the session key. In an embodiment, the proxy server 110 also receives one or more parameters of the session key from the home server 116. In an embodiment, the proxy server 110 maintains the one or more parameters of the session key. In an embodiment, maintaining the one or more parameters of the session key can include indicating the mobile device 102 that the one or more parameters have expired. For example, maintaining the session key lifetime can include indicating to the mobile node 102 that the session key lifetime has expired. Further, the proxy server 110 communicates with the mobile node 102 when the one or more parameters of the session key expire. For example, the proxy server 110 communicates to the mobile node 102 by using a FORCERENEW message. In this embodiment, services to the mobile node 102 are terminated when the one or more parameters of the session key expire. In an embodiment, the one or more parameters of the session key are stored at the proxy server 110 when the one or more parameters of the session key do not exist.

In an embodiment, the proxy server 110 manages a configurable policy based on the one or more parameters. In another embodiment, the configurable policy helps the proxy server to determine the services to be extended to mobile nodes that fail to initiate a secure communication session. In yet another embodiment, the proxy server terminates the services of the mobile node 102, based on the configurable policy. Thereafter, the process terminates at step 414.

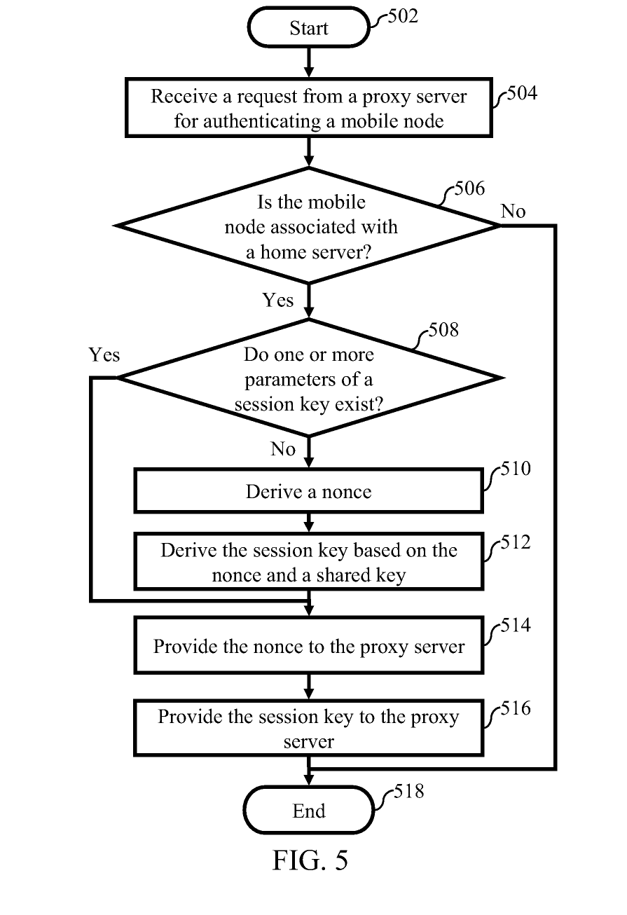

FIG. 5 is a flow diagram illustrating a method for authenticating a mobile node in a communication network, in accordance with yet another embodiment of the present invention. After initiating the process at step 502, a home server, for example, the home server 116 receives a request for authenticating a mobile node, for example, the mobile node 102, at step 504. In an embodiment, the request can include a Network Access Identifier (NAI). The NAI enables a proxy server to identify a mobile node on a network. Further, the NAI can be used by the proxy server 110 to route the request to the home server 116. In an embodiment, the home server 116 also receives at least one parameter from the proxy server 110. Further, the home server 116 uses the at least one parameter to determine one or more parameters of a session key. Moreover, the home server 116 provides one or more parameters of the session key to the proxy server 110. For example, the home server 116 can provide the lifetime of the session key to the proxy server 110.

In an embodiment, the home server 116 also receives an authentication certificate from the proxy server 110. The home server signs the authentication certificate, and has the option of signing it by using a digital signature. The authentication certificate is then provided to the proxy server 110 and validates the proxy server 110. At step 506, it is determined whether the mobile node 102 is associated with the home server 116, for example, the mobile node is an authentic mobile node. If it is determined at step 506 that the mobile node 102 is associated with the home server 116, then step 508 is performed. At step 508, it is determined whether one or more parameters of a session key exist. If it is determined at step 508 that the one or more parameters of the session key does not exist, then step 510 is performed. At step 510, the home server 116 derives a nonce. At step 512, the home server 116 derives a session key based on the nonce and the shared key. The session key authenticates the mobile node 102 to initiate a secure communication session with the proxy server 110. In an embodiment, the session key is derived by applying a hash function, an Exclusive OR (XOR) function, a simple concatenation function, or an addition function on the nonce and the shared key. At step 514, the home server 116 provides the nonce to the proxy server 110.

At step 516, the home server 116 provides the session key to the proxy server 110. In an embodiment, the home server 116 simultaneously provides the nonce and the session key to the proxy server 110. In an embodiment, the home server 116 also provides authorized configuration options for the mobile node 102 to the proxy server 110. In another embodiment, the home server 116 maintains the one or more parameters of the session key. Further, when the one or more parameters of the session key expire, the home server 116 communicates this information to the proxy server 110. For example, the proxy server 110 can store and maintain the lifetime of the session key. Further, when the lifetime of the session key expires, the proxy server 110 communicates this information to the home server 116 by using a message, for example, a FORCERENEW message. The proxy server terminates services to the mobile node when the lifetime of the session key expires. In yet another embodiment, the home server 116 receives and stores the one or more parameters of the session key when the one or more parameters of the session key do exist. If it is determined at step 508, that the one or more parameters of the session key exist, then step 514 is performed. At step 514, the nonce is provided to the proxy server 110. At step 516, the session key is provided to the proxy server 110. Thereafter, the process terminates at step 518. If it is determined at step 506, that the mobile node 102 is not associated with the home server 116, then step 518 is performed. At step 518, the process terminates.

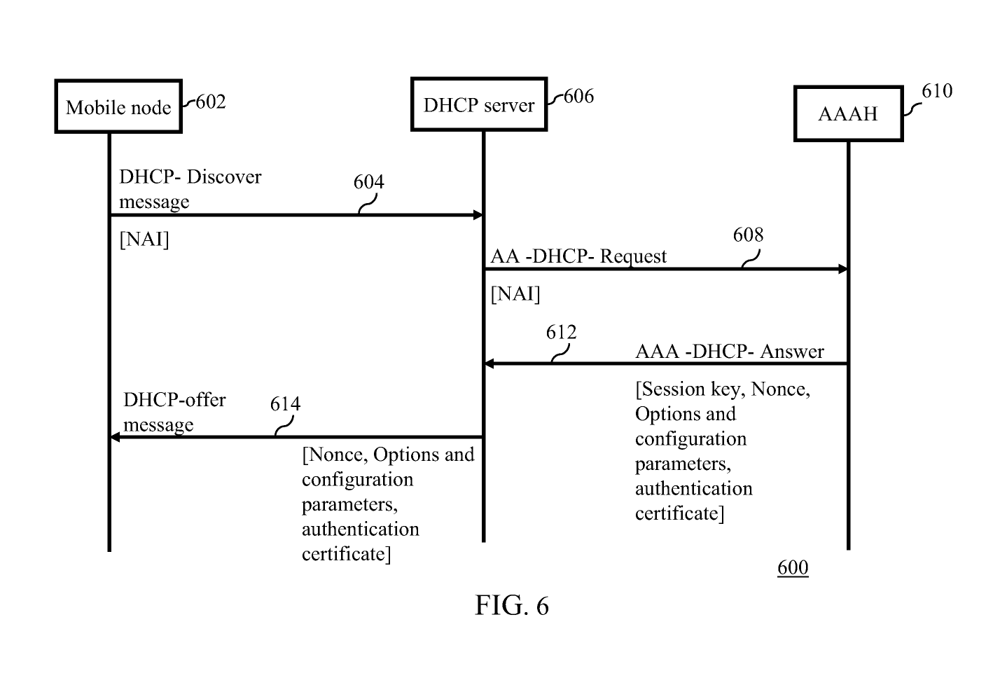

FIG. 6 is a message-flow diagram illustrating a method for authenticating a mobile node in a communication network, in accordance with another embodiment of the present invention. This embodiment will be explained in conjunction with a mobile node 602, a DHCP server 606, a Home AAA (AAAH) server 610, and an AAA protocol. The mobile node 602 and the AAAH server 610 store a shared key. The shared key uniquely associates the mobile node 602 with the AAAH server 610. Details regarding the AAA system can be found in a research paper titled ‘AAA Protocols: Authentication, Authorization, and Accounting for the Internet’ published in IEEE Internet Computing, Volume 03, Issue 6, pp. 75-79, in 1999. In a standard AAA protocol, authentication refers to the confirmation that a mobile node that is making a request for services is a valid mobile node of the network. Authorization refers to the granting of services (including “no service”) to a mobile node, based on the authentication of the mobile node, the services requested by the mobile node and the current state of the system comprising the mobile node. Authorization can be based on restrictions, for example, time-of-day restrictions or physical location restrictions. It determines the nature of the services granted to the mobile node. Accounting refers to the tracking of the consumption of network resources by a mobile node. This information may be used for management, planning and billing of the mobile node.

The authentication, authorization and accounting system adopts an AAA protocol, for example, a DIAMETER protocol, and uses an AAA server with AAA functions to carry out the process of authenticating, authorizing and accounting of mobile nodes. DIAMETER is a base protocol that can be extended to provide AAA services to mobile nodes in both local and roaming AAA situations in a communication network.

In an embodiment, when a mobile node, for example, a mobile node 602, enters a foreign network 104, the mobile node 602 sends a request for authentication in the DHCP-Discover message 604 to a the DHCP server 606. The DHCP server 606 can provide at least one parameter that is specific to the request made by the mobile node 602, to participate in the Internet Protocol (IP) network. The DHCP server 606 also provides a mechanism for the allocation of IP addresses to at least one mobile node, for example, the mobile node 602. In an embodiment, the DHCP-discover message 604 can include a Network Access Identifier (NAI), which enables the DHCP server 606 to identify the mobile node 602. Further, the NAI is used by the DHCP server to route the request to the AAAH server 610. The DHCP server 606 sends a request, for example, an AAA-DHCP-Request (ADR) 608, to the AAAH server 610. The AAAH server 610 is an AAA server in the home network 106 of the mobile node 602. In an embodiment, the DHCP server 606 sends the request to a Foreign AAA (AAAF) server and the AAAF server then routes the ADR 608 to the AAAH server 610 based on NAI. The AAAH server 610 authenticates the mobile node 602.

In an embodiment, the AAAH server 610 derives a nonce when one or more parameters of a session key do not exist. In an embodiment, the DHCP server 606 also sends at least one parameter to the AAAH server 610. The AAAH server 610 determines the one or more parameters of the session key, based on the at least one parameter. Further, the session key is derived, based on the shared key and the nonce. The session key authenticates the mobile node 602 to initiate a secure communication session with the DHCP server 606. In an embodiment, the session key is derived by applying a hash function, an Exclusive OR (XOR), a simple concatenation, or an addition function on the nonce and the shared key. The AAAH server 610 then provides the one or more parameters of the session key to the DHCP server 606. For example, the AAAH server can receive an IP lease time for the mobile node from the DHCP server. Based on the IP lease time, the AAAH server can determine the lifetime of the session key. Further, the AAAH server can provide this lifetime of the session key to the DHCP server. In an embodiment, the DHCP server 606 sends a notification to the mobile node 602 when one or more parameters of the session key expire.

In an embodiment, the AAAH server 610 stores and maintains the one or more parameters of the session key. In this embodiment, when the one or more parameters of the session key expire, the AAAH server 610 communicates this information to the mobile node 602 through the DHCP server 606. For example, the DHCP server 606 stores and maintains the lifetime of the session key. Further, when the lifetime of the session key expires, the DHCP server 606 communicates this information to the mobile node 602 by using a message, for example, a FORCERENEW message, and terminates services to the mobile node 602. In an embodiment, the AAAH server 610 receives and stores the one or more parameters of the session key when one or more parameters of the session key do not exist. Further, the AAAH server 610 provides an AAA-DHCP-Answer (ADA) 612 to the DHCP server 606. The ADA 612 includes the nonce. On receiving the ADA 612 from the AAAH, the DHCP server 606 sends a DHCP-Offer message 614 to the mobile node 602. The DHCP-Offer message 614 can include a nonce. In an embodiment, the DHCP-offer message 614 also includes authorized configuration options for the mobile node 602. Examples of the authorized configuration options include, but are not limited to, a Trivial file transfer protocol (Tftp) server name, a Mobile IP (MIP) Home Agent Internet Protocol (HA IP) address, and, a boot filename. The Tftp server name is the address of the server from where the boot file could be picked up when a request from the mobile node 102 is received. The MIP HA IP address is the IP address of a server in the home network 106, which provides the MIP home agents function for the mobile node 102. The boot filename is the name of the file which contains the boot parameters for the mobile node 102. In an embodiment, the authorized configuration options can include services the mobile node 602 is allowed to access. Examples of these services include, but are not limited to, IP address filtering, address assignment, route assignment, and Quality of Service (QoS) services. In an embodiment, the authorized configuration options are stored at the mobile node 602. In another embodiment, the DHCP-offer message 614 also includes an authentication certificate being sent to the mobile node 602. This authentication certificate validates the DHCP server 606.

Further, the AAAH server 610 provides the session key to the DHCP server 606. In an embodiment, the AAAH server 610 also provides authorized configuration options for the mobile node 602 to the DHCP server 606. In another embodiment, the AAAH server 610 receives an authentication certificate from the DHCP server 606 for signing the authentication certificate, wherein the authentication certificate validates the DHCP server 606. The AAAH server 610 signs the authentication certificate by using technologies, for example, a digital signature, and returns it to the DHCP server 606. The AAAH sends the authentication certificate to the DHCP server 606.

As described above, various embodiments of method for authenticating a mobile node in a communication network provide the following advantages. In an embodiment, a session key can be derived at the mobile node and the home server based on a nonce and the shared key. In this embodiment, as desired, the shared key is stored at a minimum number of places, for example, at the home server and the home server. The session key authenticates the mobile node to initiate a secure session with a proxy server. Further, the session key derivation is dynamic and is controlled by the home server. In an embodiment, the mobile node receives an authentication certificate from the home server, which authenticates the proxy server. In another embodiment, the DHCP server and the home (AAAH) server, makes use of an AAA Foreign (AAAF) server as an interface between them. AAAF enables the DHCP server to receive valid authorized configuration options for the mobile node. Moreover, the existing AAA diameter protocol is used to acquire the session, without making any change in the existing system.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for authenticating a mobile node in a communication network, the communication network comprising at least one proxy server, and a home server, the mobile node and the home server comprising a shared key, the shared key uniquely associating the mobile node with the home server, the method at the mobile node comprising:
sending a request for an Internet Protocol (IP) address to the at least one proxy server;
receiving a nonce in response to the request, from a proxy server of the at least one proxy server; and
deriving a session key based on the nonce and the shared key, wherein the session key authenticates the mobile node to initiate a secure communication session with the proxy server.

2. The method as recited in claim 1 further comprising sending a Network Access Identifier (NAI) to the at least one proxy server, wherein the NAI enables the at least one proxy server to identify the mobile node.

3. The method as recited in claim 1 further comprising receiving authorized configuration options for the mobile node from the at least one proxy server.

4. The method as recited in claim 3 further comprising storing the authorized configuration options.

5. The method as recited in claim 1 further comprising receiving an authentication certificate from the proxy server, the authentication certificate validating the proxy server.

6. The method as recited in claim 1 further comprising receiving a notification from the proxy server when one or more parameters of the session key expire.

7. A method for authenticating a mobile node in a communication network, the communication network comprising at least one proxy server, and a home server, the mobile node and the home server comprising a shared key, the shared key uniquely associating the mobile node with the home server, the method at a proxy server of the at least one proxy server comprising:
receiving a request for an Internet Protocol (IP) address from the mobile node;
sending the request to the home server;
receiving a nonce from the home server;
providing the nonce to the mobile node; and
receiving a session key from the home server, wherein the session key authenticates the mobile node to initiate a secure communication session with the proxy server.

8. The method as recited in claim 7 further comprising sending a message to the home server for validating the mobile node.

9. The method as recited in claim 7 further comprising:
providing at least one parameter to the home server; and
receiving one or more parameters of the session key from the home server, wherein the one or more parameters of the session key are determined based on the at least one parameter.

10. The method as recited in claim 9 further comprising:
maintaining the one or more parameters of the session key;
communicating to the mobile node when the one or more parameters of the session key expire; and
terminating services to the mobile node when the one or more parameters of the session key expire.

11. A system for authentication in a communication network, the system comprising:
a mobile node communicatively coupled via the communication network to one or more proxy servers and to a home server, wherein the mobile node is configured to send a request for an Internet Protocol (IP) address to the one or more proxy servers, and to receive in response to the request a nonce from a first proxy server of the one or more proxy servers;
a shared key stored by the mobile node and by the home server, the shared key uniquely associating the mobile node with the home server; and
a session key derived by the mobile node based on the nonce and the shared key, wherein the session key authenticates the mobile node to initiate a secure communication session with the proxy server.

12. A system for authenticating a mobile node in a communication network, the system comprising:
a proxy server communicatively coupled via the communication network to a home server and to the mobile node, the proxy server being configured to receive a request for an Internet Protocol (IP) address from the mobile node, to send the request to the home server, to receive a nonce from the home server, to provide the nonce to the mobile node, and to receive from the home server a session key;
wherein the mobile node and the home server store a shared key, the shared key uniquely associating the mobile node with the home server; and
wherein the session key authenticates the mobile node to initiate a secure communication session with the proxy server.
